(19) United States
(12) Patent Application Publication
(10) Pub. No.: US 2026/0121562 A1
(43) Pub. Date: Apr. 30, 2026

(54) ELECTRIC MACHINE WITH ROTOR INCLUDING HIGH AND LOW COERCIVITY PERMANENT MAGNETS AND SYSTEMS FOR REMAGNETIZING

(71) Applicant: GM GLOBAL TECHNOLOGY OPERATIONS LLC, Detroit, MI (US)

(72) Inventors: Alireza FATEMI, Canton, MI (US); Peng PENG, Rochester Hills, MI (US); Margarita P. THOMPSON, Livonia, MI (US); Suresh GOPALAKRISHNAN, Troy, MI (US); Thomas W. NEHL, Shelby Township, MI (US); Chandra S. NAMUDURI, Troy, MI (US)

(21) Appl. No.: 18/925,524

(22) Filed: Oct. 24, 2024

(51) Int. Cl. H02P 21/22; H02P 21/14; H02P 21/16

(52) U.S. Cl. CPC H02P 21/22; H02P 21/141; H02P 21/16; H02P 2207/05

(57) ABSTRACT

A vehicle includes a permanent magnet electric machine including a rotor including first permanent magnets and a stator including windings. A power inverter is connected to the windings of the stator. A controller is configured to estimate a magnetization level of the first permanent magnets in response to flux and back electromotive force of the permanent magnet electric machine. The controller is configured to determine at least one of an amplitude and duration of a magnetization current pulse based on the magnetization level of the first permanent magnets. The controller is configured to supply the magnetization current pulse to the windings of the stator using the power inverter when the vehicle is stationary to at least one of re-magnetize and adjust the magnetization level of the first permanent magnets of the rotor.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electric machines, and more particularly to electric machines including rotors with high and low coercivity permanent magnets and systems for re-magnetizing the low coercivity permanent magnets.

Vehicle such as battery electric vehicles (BEVs), hybrid vehicles, and/or fuel cell vehicles may include one or more electric machines that provide propulsion for a vehicle. In some examples, the permanent magnet electric machines include a rotor including permanent magnets and a stator including windings.

Permanent magnets used in automotive traction motor applications typically include rare earth permanent magnets. Rare earth permanent magnets typically produce strong magnetic fields and have high magnetic coercivity. Coercivity corresponds to the ability of the magnetic material to withstand an external magnetic field without becoming demagnetized.

### SUMMARY

A vehicle includes a permanent magnet electric machine including a rotor including first permanent magnets and a stator including windings. A controller is configured to supply a magnetization current pulse to windings of the stator when the vehicle is stationary to at least one of re-magnetize and adjust a magnetization level of the first permanent magnets of the rotor.

In other features, the magnetization current pulse has a duration less than 1 second and an amplitude greater than 1000 Amps (A). The vehicle includes a power inverter. The controller is configured to supply the magnetization current pulse to the windings of the stator using the power inverter.

In other features, the first permanent magnets have a first coercivity. The rotor includes second permanent magnets having a second coercivity. The first coercivity is less than the second coercivity. The controller is configured to align a direct axis of the permanent magnet electric machine with a net field from stator electromagnets prior to supplying the magnetization current pulse.

In other features, the vehicle includes a brake. The controller is configured to engage the brake prior to supplying the magnetization current pulse to the windings of the stator.

In other features, the vehicle includes a plurality of wheels and a clutch configured to selectively disconnect the permanent magnet electric machine from the wheels of the vehicle. The controller is configured to disengage the clutch prior to supplying the magnetization current pulse to the windings of the stator.

In other features, a temperature estimator is configured to at least one of estimate and sense a temperature of the permanent magnet electric machine. The controller is configured to supply the magnetization current pulse to the windings of the stator in response to the temperature exceeding a predetermined temperature.

In other features, the controller is configured to receive direct axis and quadrature axis current and voltages of the permanent magnet electric machine; estimate direct axis and quadrature axis flux and back electromotive force; estimate a magnetization level of the first permanent magnets in response to the direct axis and quadrature axis flux and back electromotive force; and estimate at least one of an amplitude and a duration of the magnetization current pulse based on the magnetization level of the first permanent magnets.

In other features, the controller is configured to supply the magnetization current pulse to the windings of the stator on a periodic basis. The first permanent magnets are located within a body of the rotor and between the second permanent magnets and a radially outer surface of the rotor.

A vehicle includes a permanent magnet electric machine including a rotor including first permanent magnets and a stator including windings. A power inverter is connected to the windings of the stator. A controller is configured to estimate a magnetization level of the first permanent magnets in response to flux and back electromotive force of the permanent magnet electric machine; determine at least one of an amplitude and duration of a magnetization current pulse based on the magnetization level of the first permanent magnets; and supply the magnetization current pulse to the windings of the stator using the power inverter when the vehicle is stationary to at least one of re-magnetize and adjust the magnetization level of the first permanent magnets of the rotor.

In other features, the magnetization current pulse has a duration less than 1 second and an amplitude greater than 1000 Amps.

In other features, the first permanent magnets have a first coercivity, and the rotor includes second permanent magnets having a second coercivity. The first coercivity is less than the second coercivity.

In other features, the controller is configured to align a direct axis of the permanent magnet electric machine with a net field generated by stator windings prior to supplying the magnetization current pulse.

In other features, the vehicle includes a brake. The controller is configured to engage the brake prior to supplying the magnetization current pulse to the windings of the stator.

In other features, the vehicle includes a plurality of wheels. A clutch is configured to selectively disconnect the permanent magnet electric machine from the wheels of the vehicle. The controller is configured to disengage the clutch prior to supplying the magnetization current pulse to the windings of the stator.

In other features, a temperature sensor is configured to sense a temperature of the permanent magnet electric machine. The controller is configured to supply the magnetization current pulse to the windings of the stator in response to the temperature exceeding a predetermined temperature.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a vehicle including a permanent magnet electric machine including high and low coercivity permanent magnets according to the present disclosure;

FIG. 2 is a functional block diagram of an example of a controller for re-magnetizing and/or adjusting the magnetization level of the low coercivity permanent magnets of the permanent magnet electric machine according to the present disclosure;

FIGS. 3A and 3B illustrate an example of a magnetization service tool configured to restore or adjust a magnetization level of the low coercivity permanent magnets of the permanent magnet electric machine according to the present disclosure;

FIG. 4 is a flowchart for an example of a method for restoring magnetization of the low coercivity permanent magnets according to the present disclosure;

FIG. 5 is a flowchart for an example of a method for adjusting the magnetization level of the low coercivity permanent magnets according to the present disclosure;

FIG. 6 is a cross section of an example of a rotor including high and low coercivity permanent magnets and a stator including windings according to the present disclosure;

FIG. 7 is a graph showing an example of flux percentage as a function of direct axis and quadrature axis currents for demagnetization according to the present disclosure according to the present disclosure;

FIG. 8 is a graph showing an example of flux percentage as a function of direct axis currents for restoring magnetization according to the present disclosure according to the present disclosure;

FIG. 9 is a graph showing an example of a flux density (B) and magnetic field strength (H) curves for ferrite and iron nitride permanent magnets according to the present disclosure according to the present disclosure; and

FIGS. 10A to 10C are cross sections of additional examples of rotors including high and low coercivity permanent magnets and a stator including windings according to the present disclosure.

In the drawings, reference numbers may be reused to identify similar and/or identical elements.

### DETAILED DESCRIPTION

While the present disclosure describes systems for restoring magnetization or adjusting a magnetization level of low coercivity permanent magnets used in rotors of traction motors for vehicles, the control system can be used for electric machines in stationary or other applications.

A permanent magnet (PM) electric machine can operate as a traction motor (e.g., for propulsion) or a generator (e.g., during regeneration). Permanent magnet electric machines typically include permanent magnets with high coercivity. Permanent magnets used in automotive applications typically include rare earth metals. Rare earth permanent magnets typically produce strong magnetic fields and have high magnetic coercivity.

The permanent magnet electric machine according to the present disclosure includes a rotor including both high coercivity permanent magnets and low coercivity permanent magnets to reduce cost. The permanent magnet electric machines may be operated at higher temperatures. Since coercivity is inversely proportional to temperature, operation at higher temperatures may result in demagnetization or reduced magnetization levels of the low coercivity permanent magnets. High charge/discharge currents may also reduce magnetization levels. Operation of the permanent magnet electric machine with low coercivity permanent magnets that are demagnetized or not at the desired magnetization level reduces performance.

Systems and methods according to the present disclosure impress a magnetizing current pulse over the windings of the stator to restore and/or adjust the magnetization level of the low coercivity permanent magnets in the rotor. The magnetization pulse can have a duration of a few hundred milliseconds (ms) and can be applied when the vehicle is at a standstill or during service. In some examples, flux and back electromotive force (emf) feedback/estimation are used to guide the magnetization process. In other examples, flux and back emf are not used and the magnetization pulse is applied on a periodic basis.

In some examples, a positive direct axis (d-axis) of the stator windings is used to adjust the magnetization of the low coercivity permanent magnets. In some examples, restoring or adjusting magnetization is triggered in response to elevated operating temperatures of the permanent magnet electric machine and/or after extreme charge/discharge cycles when demagnetization is more likely to occur. In some examples, magnetization is performed during vehicle standstill using short magnetization current pulses. In some examples, the brakes can be engaged during magnetization and/or the permanent magnet electric machine can be decoupled from the powertrain using a decoupling clutch. In some examples, a short magnetization pulse occurs during 1/6^{th} of an electrical cycle. In some examples, the excitation pulse amplitude is tunable for further control of a magnetization level.

The flux/back electromotive force (emf) of the permanent magnet electric machine is proportional to the magnet flux, which is a function of the magnetization level. From the estimated flux or back emf, the magnetization level can be determined and then adjusted using a lookup table or model that determines one or more parameters of the magnetization current pulse. Re-magnetization or adjusting the magnetization level can be performed using a power inverter of the vehicle or using a magnetizing service tool removably connected to two or more windings of the permanent magnet electric machine.

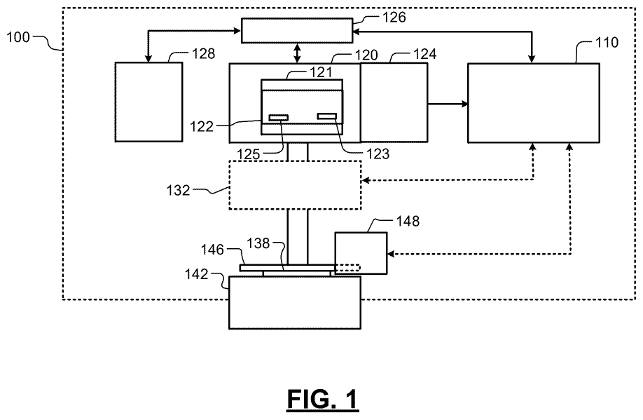

Referring now to FIG. 1, a vehicle 100 includes an electric machine 120 with a stator 121 including windings and a rotor 122 including first permanent magnets 123 (high coercivity such as rare earth permanent magnets) and second permanent magnets 125 (low coercivity such as ferrite magnets, iron nitride magnets, or other low coercivity permanent magnets). In some examples, the second permanent magnets 125 (low coercivity) have a coercivity less than 2000 Oersteds. In some examples, the first permanent magnets 123 (high coercivity) have a coercivity greater than 4000 Oersteds.

A controller 110 is configured to receive sensed parameters (e.g., current, voltage, rotor speed, temperature, etc.) from one or more sensors 124 and to control a power inverter 126 to supply power to the permanent magnet electric machine 120 from a battery pack 128 or utility. In some examples, the controller 110 is configured to determine when the second permanent magnets 125 have demagnetized (and need to be re-magnetized) and/or when adjustment of a magnetization level of the low coercivity permanent magnets needs to be performed. In other examples, the controller 110 is configured to re-magnetize or adjust the magnetization level of the low coercivity permanent magnets on a periodic basis (with or without sensing/estimating the magnetization level).

In some examples, the controller 110 is configured to optionally decouple the permanent magnet electric machine 120 from the wheels 142 of the vehicle 100 using a clutch 132 when re-magnetizing and/or adjusting the magnetization level of the second permanent magnets 125. In other examples, the controller 110 is configured to optionally apply brakes 148 (causing calipers of the brakes to clamp rotors 146 connected to a hub 138 and the wheel 142) when re-magnetizing and/or adjusting the magnetization level of the second permanent magnets 125.

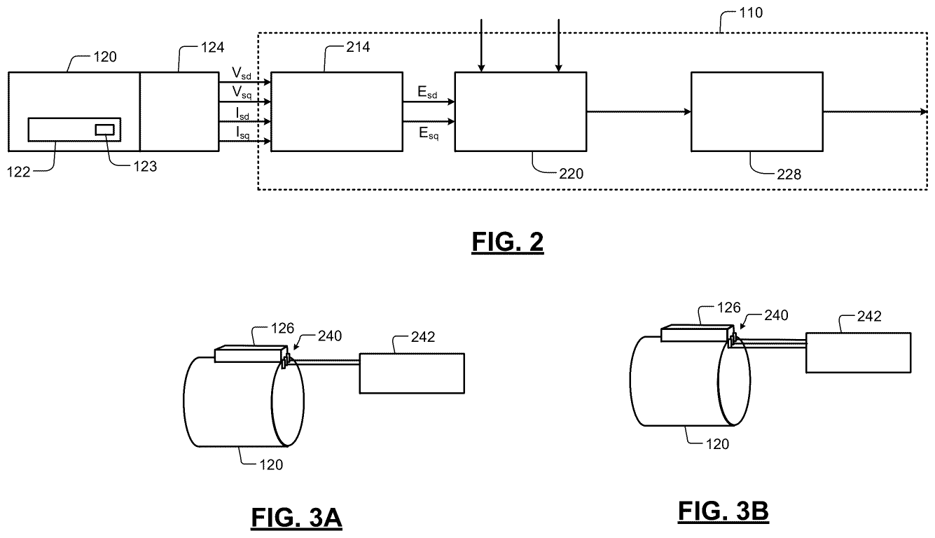

Referring now to FIG. 2, the controller 110 is configured to re-magnetize and/or adjust the magnetization level of the low coercivity permanent magnets. The controller 110 receives sensed parameters including direct axis (d-axis) and quadrature axis (q-axis) voltages and currents (e.g., V_{sd}, V_{sq}, I_{sd}, and I_{sq}). The controller 110 includes a flux and back electromotive force (emf) observer 214 configured to estimate direct axis and quadrature axis emf (e.g., E_{sd} and E_{sq}) in response to the direct axis and quadrature axis voltages and currents. A first lookup table or model 220 is configured to receive the direct axis and quadrature axis emf (E_{sd}, E_{sq}), rotor speed, and estimated rotor temperature and to calculate a magnetization level of the low coercivity permanent magnets of the permanent magnet electric machine based thereon. The magnetization level (output by the first lookup table or model 220) is input to a second lookup table or model 228 that estimates magnetization current needed to restore or adjust the magnetization level of the low coercivity permanent magnets.

In the preceding examples, the power inverter of the vehicle is used to re-magnetize or adjust the magnetization level of the low coercivity permanent magnets. Referring now to FIGS. 3A and 3B, a magnetization service tool 242 can also be used to generate the magnetization pulse. In FIG. 3A, the d-axis of the permanent magnet electric machine is aligned with the low coercivity permanent magnets and then the magnetization service tool 242 is connected to two or more phase windings 240 of the permanent magnet electric machine 120 to re-magnetize or adjust the magnetization level of the low coercivity permanent magnets. In FIG. 3B, the magnetization service tool 242 is connected to the three phase windings 240 of the permanent magnet electric machine 120 to re-magnetize or adjust the magnetization level of the low coercivity permanent magnets (with or without alignment with of the d-axis with the low coercivity permanent magnets). In some examples, the d-axis is aligned with a net field from stator electromagnets prior to supplying the magnetization current pulse.

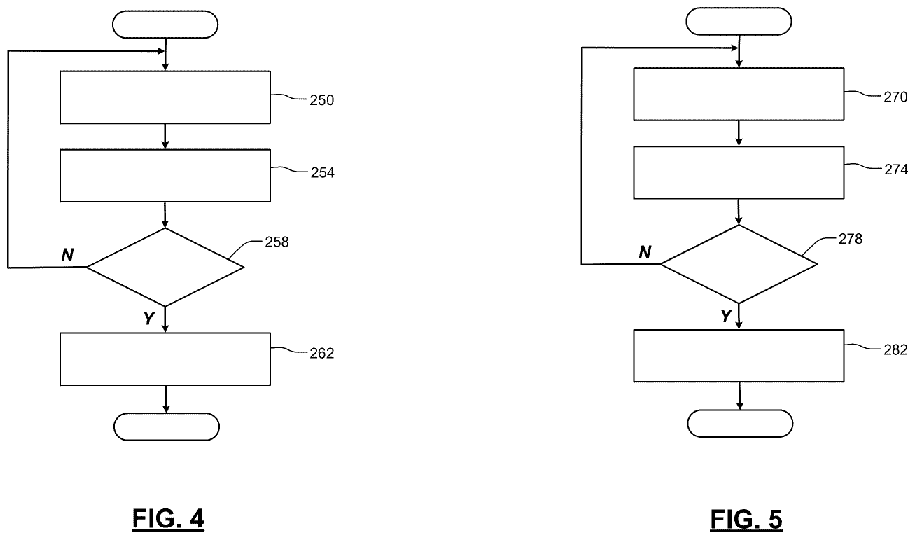

Referring now to FIG. 4, a method for demagnetizing and restoring magnetization of the low coercivity permanent magnets is shown. At 250, the method estimates rotor temperature, senses voltages, currents, and rotor speed, and estimates flux and back emf. At 254, the method evaluates the magnetization level (e.g., demagnetization evaluation). At 258, the method determines whether demagnetization has occurred based on the magnetization level. If true, the method re-magnetizes the low coercivity permanent magnets at 262.

Referring now to FIG. 5, a method for adjusting magnetization of the low coercivity permanent magnets is shown. At 270, the method estimates rotor temperature, senses voltages, currents, and rotor speed, and estimates flux and back emf. At 274, the method evaluates the magnetization level. At 278, the method determines whether magnetization adjustment is needed. If true, the method adjusts magnetization level of the low coercivity permanent magnets at 262.

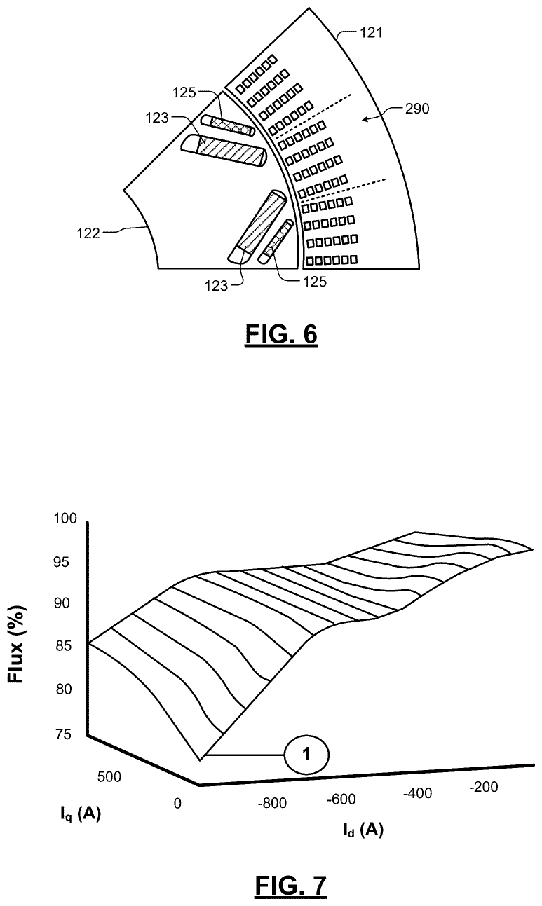

Referring now to FIG. 6, the rotor 122 includes the first permanent magnets 123 having high coercivity and the second permanent magnets 125 having low coercivity. The stator 121 includes windings 290. In some examples, the second permanent magnets 125 include ferrite magnets or iron nitride (FeN) magnets. In this example, the second permanent magnets 125 are arranged at an acute angle relative to a radial direction of the rotor.

Referring now to FIG. 7, a graph shows an example of flux percentage as a function of q-axis and d-axis currents. The graph can be used by the controller during de-magnetization analysis and/or for adjusting the magnetization level of the low coercivity permanent magnets.

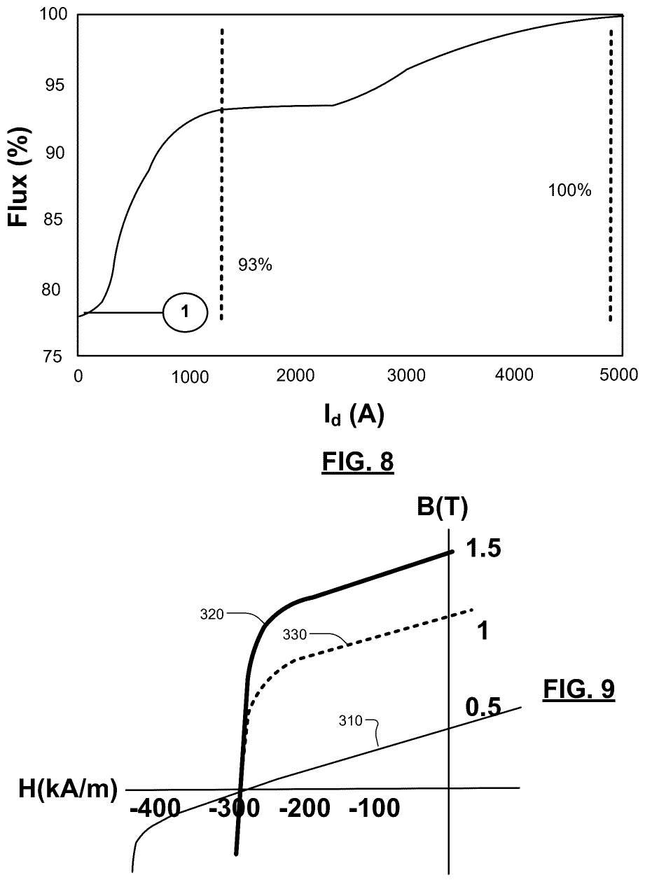

In FIG. 8, a graph shows flux density (B) and magnetic field strength (H) curves for ferrite and iron nitride magnets. Re-magnetization and/or adjusting the magnetization level of the low coercivity permanent magnets requires a high strength magnetic field that can be generated by a short magnetization current pulse (typically at a high current amplitude over a few hundred milliseconds). Switches in the power inverter are capable of withstanding high current amplitudes for short durations (e.g., less than 0.5 or 1 second or a few hundred milliseconds). As can be seen in FIG. 8, a current pulse of approximately 1200 Amps (A) can be used to restore the magnetic field strength of the low coercivity permanent magnets to about 93%. However, a current pulse of approximately 5000 Amps (A) is needed to restore the magnetic field strength of the low coercivity permanent magnets to about 100%.

As can be appreciated, the amplitude of the current pulse for re-magnetizing or adjusting the magnetization level can be set in response to the current ratings of the switches used in the power inverter or other components of the vehicle. In other words, the magnetization level may be set to a value less than 100% when re-magnetizing or adjusting the magnetization level using the power inverter to increase durability. Higher current levels may be used when the magnetizing service tool is used since the switches of the power inverter are not used.

In FIG. 9, an example of a B-H curve 310 for ferrite and a B-H curve 320 for iron nitride magnets is shown. During operation at higher temperatures and/or after high charge/discharge cycles, the B-H curve 320 of the iron nitride magnets (for example) changes as shown at 330.

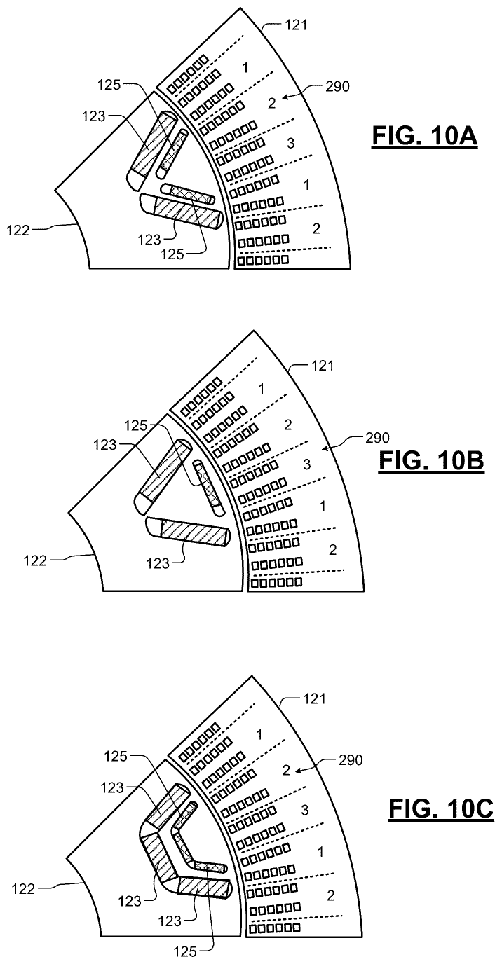

Referring now to FIGS. 10A to 10C, other examples of rotors including high and low coercivity permanent magnets are shown. In FIG. 10A, the rotor 122 includes the first permanent magnets 123 having high coercivity and the second permanent magnets 125 having low coercivity. The stator 121 includes the windings 290. A pair of the first permanent magnets 123 is arranged in a “V” shape that is symmetric about a radial direction of the rotor 122. In some examples, the pair of the first permanent magnets 123 forms an acute angle relative to the radial direction (e.g., less than 45°). The first permanent magnets 123 are located radially inside of a pair of the second permanent magnets 125. The pair of the second permanent magnets 125 are located in the body of the rotor adjacent to a radially outer edge of the rotor 122. The second permanent magnets 125 also have a “V” shape that is symmetric about a radial direction of the rotor 122. The pair of the second permanent magnets 123 forms an acute angle relative to the radial direction (e.g., less than 45°).

In FIG. 10B, the first permanent magnets 123 are arranged in a “V”-shape radially inside of the second permanent magnets 125. In this example, the second permanent magnets 125 include a single low coercivity permanent magnet arranged approximately parallel to a line tangent to a radially outer surface of the rotor (and perpendicular to the d-axis).

In FIG. 10C, the first permanent magnets 123 include first, second, and third high coercivity permanent magnets arranged in a “U”-shape that is symmetric about a radial direction of the rotor 122. In some examples, first and second ones of the first permanent magnets 123 are arranged at an acute angle relative to the radial direction (e.g., less than 45°) and a third one is arranged between radially inner ends of the first and second ones and perpendicular to the radial direction. The first permanent magnets 123 are located radially inside of the second permanent magnets 125.

The second permanent magnets 125 include first, second, and third low coercivity permanent magnets arranged in a “U”-shape that is symmetric about a radial direction of the rotor 122. In some examples, first and second ones of the first permanent magnets 123 are arranged at an acute angle relative to the radial direction (e.g., less than 45°) and a third one is arranged between radially inner ends of the first and second ones and perpendicular to the radial direction. As can be appreciated, the high and low coercivity permanent magnets can be arranged in other ways.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle comprising:
a permanent magnet electric machine including:
a rotor including first permanent magnets; and
a stator including windings; and
a controller configured to supply a magnetization current pulse to windings of the stator when the vehicle is stationary to at least one of re-magnetize and adjust a magnetization level of the first permanent magnets of the rotor.

2. The vehicle of claim 1, wherein the magnetization current pulse has a duration less than 1 second and an amplitude greater than 1000 Amps.

3. The vehicle of claim 1, further comprising:
a power inverter,
wherein the controller is configured to supply the magnetization current pulse to the windings of the stator using the power inverter.

4. The vehicle of claim 1, wherein:
the first permanent magnets have a first coercivity, and
the rotor includes second permanent magnets having a second coercivity,
wherein the first coercivity is less than the second coercivity.

5. The vehicle of claim 1, wherein the controller is configured to align a direct axis of the permanent magnet electric machine with a net field from stator electromagnets prior to supplying the magnetization current pulse.

6. The vehicle of claim 1, further comprising:
a brake,
wherein the controller is configured to engage the brake prior to supplying the magnetization current pulse to the windings of the stator.

7. The vehicle of claim 1, further comprising:
a plurality of wheels; and
a clutch configured to selectively disconnect the permanent magnet electric machine from the wheels of the vehicle,
wherein the controller is configured to disengage the clutch prior to supplying the magnetization current pulse to the windings of the stator.

8. The vehicle of claim 1, further comprising:
a temperature estimator configured to at least one of estimate and sense a temperature of the permanent magnet electric machine,
wherein the controller is configured to supply the magnetization current pulse to the windings of the stator in response to the temperature exceeding a predetermined temperature.

9. The vehicle of claim 1, wherein the controller is configured to:
receive direct axis and quadrature axis current and voltages of the permanent magnet electric machine;
estimate direct axis and quadrature axis flux and back electromotive force;
estimate a magnetization level of the first permanent magnets in response to the direct axis and quadrature axis flux and back electromotive force; and
estimate at least one of an amplitude and a duration of the magnetization current pulse based on the magnetization level of the first permanent magnets.

10. The vehicle of claim 1, wherein the controller is configured to supply the magnetization current pulse to the windings of the stator on a periodic basis.

11. The vehicle of claim 4, wherein the first permanent magnets are located within a body of the rotor and between the second permanent magnets and a radially outer surface of the rotor.

12. A vehicle comprising:
a permanent magnet electric machine including:
a rotor including first permanent magnets; and
a stator including windings;
a power inverter connected to the windings of the stator; and
a controller configured to:
estimate a magnetization level of the first permanent magnets in response to flux and back electromotive force of the permanent magnet electric machine;
determine at least one of an amplitude and duration of a magnetization current pulse based on the magnetization level of the first permanent magnets; and
supply the magnetization current pulse to the windings of the stator using the power inverter when the vehicle is stationary to at least one of re-magnetize and adjust the magnetization level of the first permanent magnets of the rotor.

13. The vehicle of claim 12, wherein the magnetization current pulse has a duration less than 1 second and an amplitude greater than 1000 Amps.

14. The vehicle of claim 12, wherein:
the first permanent magnets have a first coercivity, and
the rotor includes second permanent magnets having a second coercivity,
wherein the first coercivity is less than the second coercivity.

15. The vehicle of claim 12, wherein the controller is configured to align a direct axis of the permanent magnet electric machine with a net field generated by stator windings prior to supplying the magnetization current pulse.

16. The vehicle of claim 11, further comprising:
a brake,
wherein the controller is configured to engage the brake prior to supplying the magnetization current pulse to the windings of the stator.

17. The vehicle of claim 11, further comprising:
a plurality of wheels; and
a clutch configured to selectively disconnect the permanent magnet electric machine from the wheels of the vehicle,
wherein the controller is configured to disengage the clutch prior to supplying the magnetization current pulse to the windings of the stator.

18. The vehicle of claim 11, further comprising:
a temperature sensor configured to sense a temperature of the permanent magnet electric machine,
wherein the controller is configured to supply the magnetization current pulse to the windings of the stator in response to the temperature exceeding a predetermined temperature.

19. A system comprising:
a vehicle including a permanent magnet electric machine including:
a rotor including first permanent magnets having a first coercivity; and
a stator including windings; and
a magnetization service tool configured to supply a magnetization current pulse to the windings of the stator when the vehicle is stationary to at least one of re-magnetize and adjust a magnetization level of the first permanent magnets of the rotor.

20. The system of claim 19, wherein the vehicle further comprises:
brakes;
wheels;
a controller configured to at least one of decouple the permanent magnet machine from the wheels of the vehicle and apply the brakes of the vehicle.
